(19) United States
(12) Patent Application Publication
(10) Pub. No.: US 2013/0309095 A1
(43) Pub. Date: Nov. 21, 2013

(54) WIND TURBINE BLADE HAVING IMPROVED STRUCTURAL AND AERODYNAMIC CHARACTERISTICS

(71) Applicant: Gerald E. Brock, Livonia, NY (US)

(72) Inventor: Gerald E. Brock, Livonia, NY (US)

(73) Assignee: SkyWolf Wind Turbine Corp., Geneseo, NY (US)

(21) Appl. No.: 13/473,642

(22) Filed: May 17, 2012

(51) Int. Cl. F03D 11/00

(52) U.S. Cl. 416/226

(57) ABSTRACT

A wind turbine blade is provided which is attached to a hub of a wind turbine. The wind turbine blade includes a spine. The spine can have various cross-sections, such as square, rectangular, triangular, “I” beam, or other suitable cross-sections. An attachment member is connected to one end of the spine. Ribs are provided and the spine extends through apertures in each of the ribs. A facing is attached to the plurality of ribs. The facing forms a convex surface on one side and a substantially flat surface on the other side. The flat surface is at an angle of between 24 degrees and 28 degrees from a plane perpendicular to the axis of rotation of the blades near a proximal end of the blade and the flat surface is at an angle of between 8 degrees and 12 degrees at the distal end of the blade.

### FIELD OF THE INVENTION

The present invention relates to wind turbine blades. More particularly, the invention relates to wind turbine blades having improved structural and aerodynamic characteristics

### BACKGROUND OF THE INVENTION

Modern wind turbines include a plurality of wind turbine blades, typically three to eight blades. Traditionally, a blade comprises two shell parts, one defining a windward side shell part and the other defining a leeward side shell part. Each of the shell parts are traditionally made in one piece. To reinforce such a blade, a spine can act as a reinforcing beam. Ribs can extend in a transverse direction from the spine to which the shell parts are attached. Typically, the profile of the turbine blade, as viewed in transverse cross-section, is concave on one surface and convex on the other. In addition, the turbine blades are typically oriented at a constant angle with respect to the hub.

A turbine blade is needed which provides enhanced structural and aerodynamic characteristics compared to those blades of the past.

### BRIEF SUMMARY OF THE INVENTION

The present invention includes a wind turbine blade which is attached at an attachment face to a hub of a wind turbine. The wind turbine blade includes a central spine. Although the spine need not be hollow, it is preferable to construct the spine in such a way to maximize its strength with a minimum of weight. Providing a hollow spine is one way to achieve such design characteristics. The spine can have various cross-sections, such as square, rectangular, triangular, “I” beam, or other suitable lightweight and strong cross-sectional configurations. An attachment member is connected to one end of the spine. Alternatively, the attachment member may be integral with the spine. The attachment member is connected to the hub of the wind turbine. The blade includes ribs and the spine extends through an aperture in each of the ribs. The ribs have a curved edge and a flat edge. The curved edge may be symmetrical or asymmetrical, as, for example, in the cross-sectional shape of a common airfoil. A facing is attached to the plurality of ribs. The facing forms a convex surface corresponding to the curved edge of the ribs and a substantially flat surface corresponding to the flat edge of the ribs. The flat surface is at an angle of between 24 degrees and 28 degrees from a plane perpendicular to the axis of rotation of the blades near a proximal end of the blade and the flat surface at an angle of between 8 degrees and 12 degrees at the distal end of the blade. Preferably, the angle between the plane perpendicular to the axis of rotation and the flat surface at the proximal end is 24 degrees and the angle between the plane perpendicular to the axis of rotation and the flat surface of the distal end is 10 degrees. These angles provide optimal aerodynamic characteristics.

The components of the turbine blade of the present invention may be made from plastic, fiber reinforced plastic, aluminum, other suitable materials, and/or combinations thereof. The turbine blade constructed according to the teachings of the present invention is lightweight, structurally sound and aerodynamically efficient. By placing the spine through the interior portion of each rib, a strong structure is created which is able to withstand the forces created by high winds, while minimizing the weight and loss of efficiency. In addition, by attaching the facing to the entire outer perimeter of each rib, the facing is fully supported by these ribs further adding to the structurally sound construction.

### BRIEF DESCRIPTION OF THE SEVERAL VIEWS OF THE DRAWINGS

The foregoing and other objects, features, and advantages of the invention will be apparent from the following drawings and more particular description of the preferred embodiments of the invention.

FIG. 1 is a perspective view of the turbine blades of the present invention;

FIG. 2 is an exploded perspective view of a single turbine blade of the invention of FIG. 1;

FIG. 3 is a front elevation view of turbine blades of the present invention attached to a hub of a wind turbine; and

FIG. 4 is a perspective view of the internal structure of a turbine blade of FIG. 1.

### DETAILED DESCRIPTION OF THE INVENTION

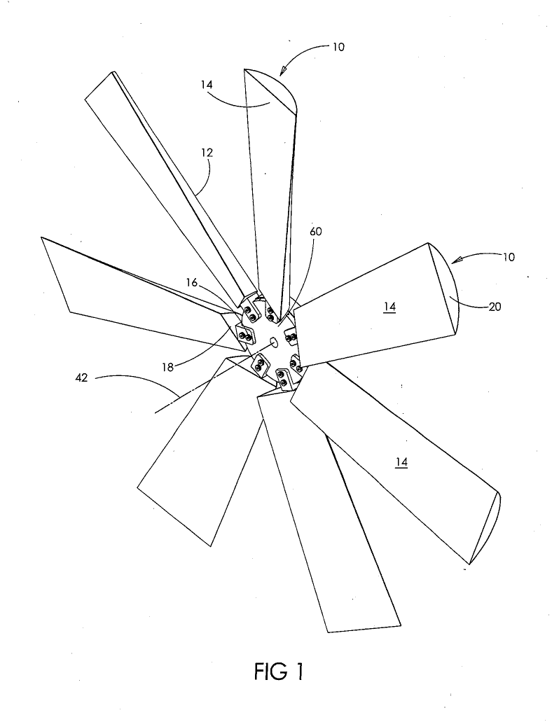

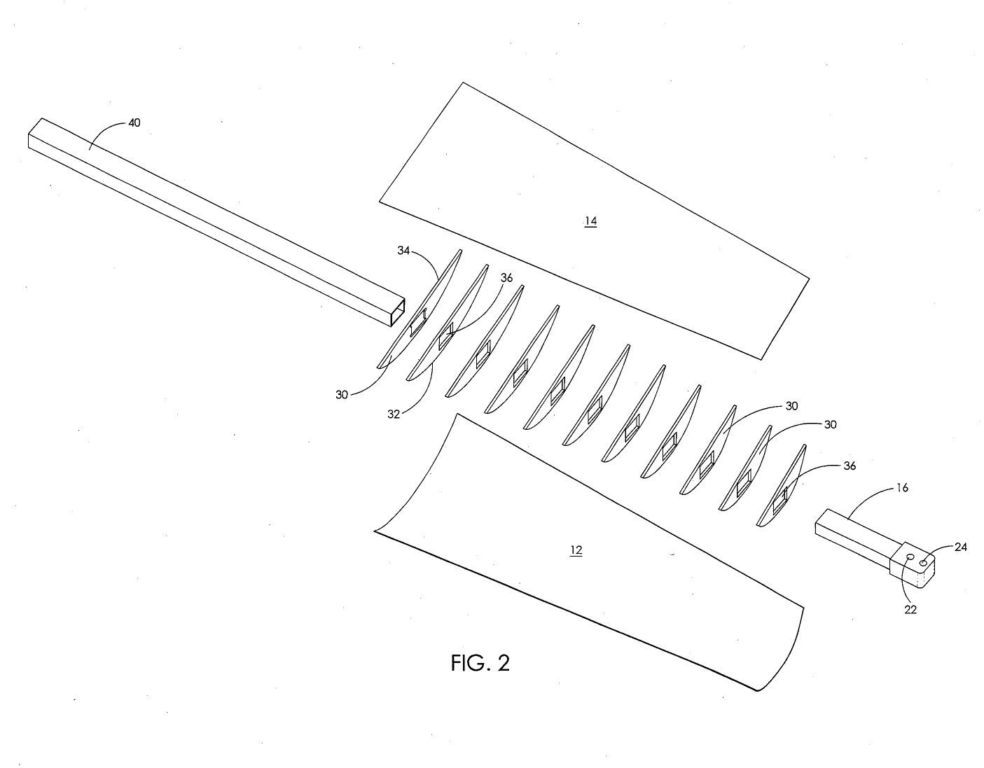

FIGS. 1 through 4 illustrate the invention. In FIG. 1, blades 10 are shown having a facing with a curved surface 12 and a facing with a flat surface 14. The cross-section of the blade 10 is generally semi-circular. An attachment member 16 projects from the proximal end 18 of the blade 10, opposite the distal end 20. Bolt holes 22 and 24 (FIG. 2) are provided through attachment member 16.

FIG. 2 shows an exploded view of the blade 10. Ribs 30 are provided with a curved edge 32 and a flat edge 34. Each of the ribs 30 has an aperture 36 through it. A spine 40 is provided with a cross-section corresponding to the shape of the aperture 36 such that the spine 40 fits within the aperture 36 of the ribs 30 and is attached by any conventional means such as welding, adhesives, or mechanical attachment. The attachment member 16 may be integral to or separate from the spine 40.

By changing the orientation of the apertures 36 with respect to one another, the angle of the blade with respect to a plane perpendicular to the axis of rotation 42 can change along the length of the blade 10 from the proximal end 18 to the distal end 20. An angle of 24 degrees between the plane perpendicular to the axis of rotation 42 and the proximal end 18, and an angle of 10 degrees between the plane perpendicular to the axis of rotation 42 and the distal end 20 of the blade provides excellent aerodynamic properties.

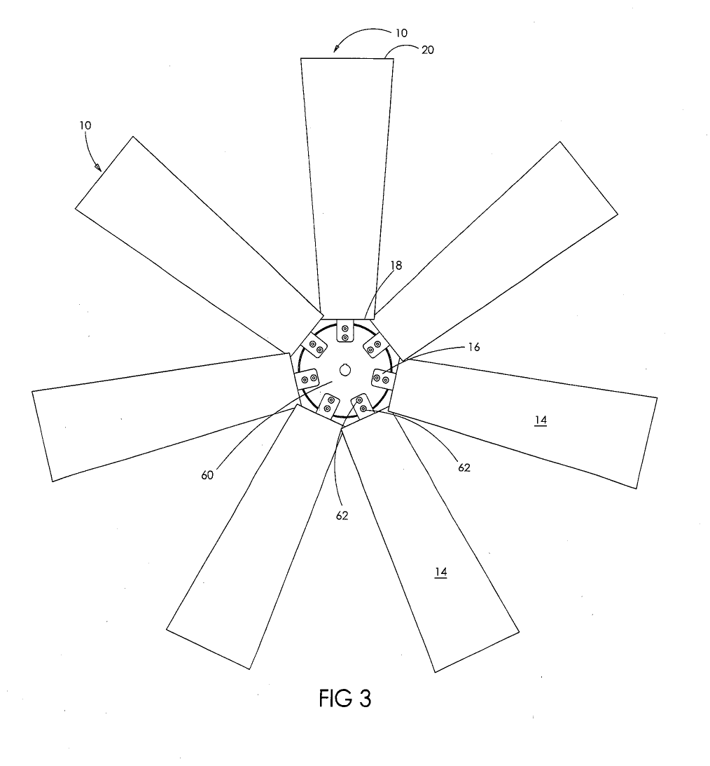

FIG. 3 shows one method of attaching the blades 10 to the hub 60. Bolts 62 are used to attach the blades 10 to the hub 60. Those skilled in the art will appreciate that many other attachment methods are possible. The blades 10 extend in a radial direction from the hub 60. Seven blades are shown in FIG. 3, however, different blade configurations are possible.

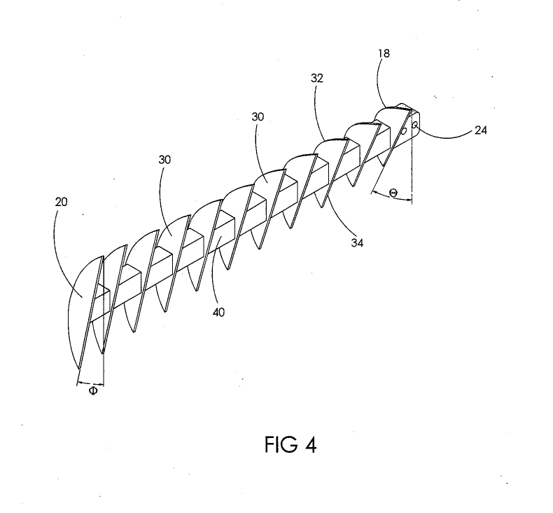

FIG. 4 illustrates the varying angle of the blade 10 along its length from the proximal end 18 to the distal end 20. Preferably, the angle between the plane perpendicular to the axis of rotation 42 and the flat side of the blade 10 at the proximal end 18, represented by θ is 24 degrees. Preferably, the angle between the plane perpendicular to the axis of rotation 42 and the flat side of the blade 10 at the distal end 20, represented by Φ is 12 degrees.

1. A wind turbine blade for attaching to a hub of a wind turbine, the hub having an axis of rotation, comprising:
a spine;
a attachment member at one end of the spine;
the attachment member connected to the hub;
a plurality of ribs, the spine extending through apertures in each of the plurality of ribs, the ribs having a curved edge and a flat edge;
a facing attached to the plurality of ribs, the facing forming a convex surface corresponding to the curved edge of the ribs and a substantially flat surface corresponding to the flat edge of the ribs, the flat surface at an angle of between 24 degrees and 28 degrees from a plane perpendicular to the axis of rotation near a proximal end of the blade and the plane perpendicular to the axis of rotation at an angle of between 8 degrees and 12 degrees at the distal end of the blade.

2. The wind turbine blade of claim 1 wherein the spine is rectangular in cross-section and wherein each of the ribs in the plurality of ribs has an aperture corresponding to the cross-section of the spine.

3. The wind turbine blade of claim 1 wherein the spine has a square cross-section and wherein each of the ribs in the plurality of ribs has an aperture corresponding to the cross-section of the spine.

4. The wind turbine blade of claim 1 wherein the angle between the plane perpendicular to the axis of rotation and the flat surface is 24 degrees at the proximal end of the blade.

5. The wind turbine blade of claim 1 wherein the angle between the plane perpendicular to the axis of rotation and the flat surface is 10 degrees at the distal end of the blade.
